(19) United States
(12) Patent Application Publication
(10) Pub. No.: US 2016/0354949 A1
(43) Pub. Date: Dec. 8, 2016

(54) PROCESS FOR PRODUCING PARTICLES OF GRANULATED MATERIAL FROM A MOLTEN MATERIAL

(71) Applicant: MAAG AUTOMATIK GMBH, Grossostheim (DE)

(72) Inventors: Stefan Deiss, Harxheim (DE); Burkard Kampfmann, Mombris (DE); Reinhardt-Karsten Murb, Aschaffenburg (DE)

(21) Appl. No.: 15/174,854

(22) Filed: Jun. 6, 2016

Related U.S. Application Data
(63) Continuation of application No. PCT/EP2014/003232, filed on Dec. 3, 2014.

(30) Foreign Application Priority Data
Dec. 5, 2013 (DE) 102013020316.3

(51) Int. Cl. B29B 9/06; B29C 35/16; B29C 47/00

(52) U.S. Cl. CPC B29B 9/065; B29C 47/0011; B29C 47/0066; B29C 35/16; B29C 2035/1683; B29K 2101/12

(57) ABSTRACT

A method for making granules from a melt material extruded by being pressed through nozzle openings of a perforated plate in a cutting chamber. In this process, the melt material emerging from the nozzle openings of the perforated plate is cut into molten granules in the cutting chamber by at least one rotating cutting knife that sweeps across the nozzle openings. A first coolant flow of a first coolant medium is delivered through a first coolant inlet to at least one first coolant port, with which the melt material is cooled when emerging and being cut at the perforated plate. Furthermore, a second coolant flow of a second coolant medium different from the first is delivered through a second coolant inlet to at least one second coolant port downstream of the perforated plate, with which the granules are additionally cooled and conveyed to an outlet of the cutting chamber.

### CROSS REFERENCE TO RELATED APPLICATIONS

The present patent application is a Continuation that claims priority to and the benefit of co-pending International Patent Application No. PCT/EP2014/003232 filed Dec. 3, 2014, entitled “APPARATUS AND PROCESS FOR GRANULATING MOLTEN MATERIAL”, which claims priority to DE Application No. 102013020316.3 filed Dec. 5, 2013. These references are hereby incorporated in their entirety.

### FIELD

The present embodiments generally relate to a method for making granules from a melt material.

### BACKGROUND

The embodiments relate to a method for making granules from a melt material. First a melt material can be produced and extruded, with the melt material being pressed through nozzle openings of a perforated plate in a cutting chamber. In this process, the melt material emerging from the nozzle openings of the perforated plate can be cut into molten granules by at least one rotating cutting knife of the cutting chamber that sweeps across the nozzle openings. A first coolant flow of a first coolant medium is delivered through a first coolant inlet to at least one first coolant port, with which the melt material is cooled when emerging and being cut at the perforated plate.

A method of this nature is known in the prior art and serves to transform a thermoplastic polymer into a granular form. In a typical embodiment, water is used as the coolant, wherein the coolant inlet comprises a tube that is closed at the end and is provided with transverse bores as coolant ports, through which transverse bores cooling water is directed onto rotating cutting knives so the melt material is cooled when emerging from being cut at the perforated plate.

One disadvantage of the prior art granulating method is that the coolant feed for discharging the granules cannot be regulated independently of the coolant feed to the cutting knives, so that in the event of excessive coolant throughput for reliable discharge of the granules from the granulating device, there is a risk of the melt material freezing-up in the nozzle openings of the perforated plate.

This is especially evident in the known granulating method since the entire coolant flow consisting of a granule discharge flow and a granule cooling flow is directed directly at the cutting knives at the perforated plate. With a reduced coolant throughput there is a risk that the granules are not adequately solidified and that sticking and/or clumping can take place at the cutting knives and/or at the walls of the cutting chamber.

In addition, an underwater granulating device for thermoplastic plastics is known in the prior art. In this type of granulating device, a cutting knife head can be concentrically enclosed by a hood. In this type of granulating method, a first part of the cooling water flow can be directed around the outside of the hood and a second part of the cooling water flow can be delivered to the cutting knife head through an opening in the hood.

Located in the cutting knife head there can be bores that provide the cooling water that flows into the hood for direct granule cooling. The cooling water that flows outside around the hood can be provided for discharging the granules from the granulating device, while the portion of the cooling water that flows through the cutting knife head can be directed in such a manner that the melt material is cooled directly when emerging and being cut at the perforated plate.

One disadvantage of the granulating method that can be performed with this prior art underwater granulating device is that the granule discharge flow for discharging the granules from the granulator housing cannot be separated from the granule cooling flow that is intended to cool the granules directly during cutting, since the two coolant inlets for both partial cooling water flows are provided in one common coolant inlet pipe.

Consequently, with this prior art granulating device it is not possible to create an optimum balance between a granule discharge flow and a granule cooling flow, on the one hand in order to prevent clumping of the granules in the granule discharge flow in the event of insufficient cooling of the granules, and on the other hand to avoid freeze-up of the melt strand in the nozzle openings of the perforated plate in the event of excessively high granule cooling flow, without the need to completely rebuild the granulating device.

Yet another prior art device for the cutting, cooling, and removal of granules is known in which the drive shaft of a cutting knife head is entirely or partially hollow in design and serves as a feed pipe for the cooling water and discharge water. The cutting knife head can have blade arms that likewise are hollow in design so that the cut-off granules entering and collected in the blade arm can be carried away therein centrifugally with a water flush.

This type of granulating device has the disadvantage that the cutting knife head consisting of blade arms is extremely complex in its construction and the cross-section of the hollow drive shaft with the cutting knife head is limited, thus restricting the amount of coolant per unit time in the granulating method such that, firstly, there is a risk that the granules are not adequately cooled before they are delivered to an outlet, which can lead to sticking and/or clumping, both in the cutting blade arms and in the granulator housing, a possibility that is increased as a result of the centrifugal acceleration by the coolant-carrying hollow blade arms.

Another disadvantage is that the coolant medium for discharging granules cannot be delivered independently of the coolant medium to the cutting knife head, so that in the event of excessive central coolant feed for reliable discharge of the granules from the granulating device, there is a risk of the melt material freezing-up in the nozzle openings of the perforated plate, especially since the entire coolant flow consisting of the granule discharge flow and granule cooling flow is carried past the nozzle openings of the perforated plate in this granulating device.

One object of the present invention is to create a method for making granules from a melt material that delivers independent coolant flows to the cut granules, firstly ensuring direct cooling at cutting of the granules from the perforated plate, and secondly ensuring a discharge of the granules from the granulator housing that is virtually independent thereof, without causing a granule blockage or sticking or clumping of the granules on walls and the cutting knife head as a result of inadequate coolant throughput in a granule discharge flow.

The present embodiments meet this object.

### BRIEF DESCRIPTION OF THE DRAWINGS

The detailed description will be better understood in conjunction with the accompanying drawings as follows:

FIG. 1 shows a schematic, partially cross-sectional view of a granulating device for carrying out the method according to a first example for carrying out the invention.

FIG. 2 shows a schematic, partially cross-sectional view of a granulating device for carrying out the method according to a second example for carrying out the invention.

FIG. 3 shows a schematic, partially cross-sectional view of a granulating device for carrying out the method according to a third example for carrying out the invention.

FIG. 4 shows a schematic, partially cross-sectional view of a granulating device for carrying out the method according to a fourth example for carrying out the invention.

FIG. 5 shows a schematic, partially cross-sectional view of a granulating device for carrying out the method according to a fifth example for carrying out the invention.

FIG. 6 shows a schematic, partially cross-sectional view of a granulating device for carrying out the method according to a sixth example for carrying out the invention.

The present embodiments are detailed below with reference to the listed Figures.

### DETAILED DESCRIPTION OF THE EMBODIMENTS

Before explaining the present method in detail, it is to be understood that the method is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The embodiments relate to a method for making granules from a melt material. First a melt material can be produced and extruded, with the melt material being pressed through nozzle openings of a perforated plate in a cutting chamber. In this process, the melt material emerging from the nozzle openings of the perforated plate can be cut into molten granules by at least one rotating cutting knife of the cutting chamber that sweeps across the nozzle openings. A first coolant flow of a first coolant medium is delivered through a first coolant inlet to at least one first coolant port, with which the melt material is cooled when emerging and being cut at the perforated plate.

An example for carrying out the method for making granules from a melt material has the following method steps. First a melt material can be produced and extruded, with the melt material being pressed through nozzle openings of a perforated plate in a cutting chamber. In this process, the melt material emerging from the nozzle openings of the perforated plate can be cut into molten granules in the cutting chamber by at least one rotating cutting knife that sweeps across the nozzle openings.

A first coolant flow of a first coolant medium can be delivered through a first coolant inlet to at least one first coolant port, with which the melt material can be cooled when emerging and being cut at the perforated plate. Furthermore, a second coolant flow of a second coolant medium different from the first can be delivered through a second coolant inlet to at least one second coolant port downstream of the perforated plate, with which the granules are additionally cooled and conveyed to an outlet of the cutting chamber.

This example for carrying out the method for making granules from a melt material has the advantage that two coolant flows that are different and completely independent of one another for making granules can be delivered to a cutting chamber of a granulating facility. In this way, boundary and startup conditions of the granulating method can be configured relatively freely and thus optimized. Even though the tasks of the first coolant flow and of the second coolant flow are defined for the granulating method to the effect that the first coolant flow with the first coolant medium serves the purpose of granule cooling at cutting of the melt material at the perforated plate and the second coolant flow is provided for transport of the granules in the cutting chamber to the outlet of the cutting chamber, the properties of the coolant media can nevertheless provide for optimal performance of the granulating method, so the method can be performed with great variance that was unattainable with previous granulating methods.

The possibilities for variation of the granulating method can be further improved if, in a third example for carrying out the method, a third coolant flow of a third, different coolant medium is provided that is delivered through third coolant ports and additionally cools the granules. This third coolant flow can have the advantage that it is either added to the granule discharge flow or can additionally serve the granule cooling flow directly at the perforated plate. If three independent cooling flows are available, it is also possible for two different first coolant flows to precool the granules in the region of the cutting knife upon emergence and cutting at the perforated plate and for another independent coolant flow to be provided for transport of the granules within the cutting chamber.

In another example for carrying out the method for making granules, provision can be made that the granules are cooled by first and at least second coolant media with different physical states, for example wherein an aerosol or mist can be used as the first coolant medium and a dry gas or inert gas as the second coolant medium, or vice versa. If an aerosol is used as the first coolant medium, it can consist of both gases plus dust particles, so-called airborne dust, wherein the dust particles can have a particle size as small as 0.5 nm.

When discharged through first coolant ports with which the melt material is cooled when emerging and being cut at the perforated plate, these nanoparticles can provide for a solid particle crust on the surface of the granules or for a solid coating on the granules and thereby significantly reduce the stickiness of melt granules that are produced upon emergence and cutting at the perforated plate. Such nanoparticles of the aerosol also have the advantage that coatings of solid particles can form a jacket for the granules such as is desirable for pharmaceutical products.

Moreover, the aerosol can also contain liquid particles, as is the case with mist, for example. During cutting of melt granules at the perforated plate, aerosols of this type enriched with liquid particles have the advantage that they remove heat from the melt granules relatively rapidly and effectively due to the heat of evaporation that such liquid particles require. Since the aerosol environment has primarily gases, the liquid particles can evaporate relatively unhindered and can remove heat from the melt granules more efficiently than air or conventional dry gases. In order to ensure reliable transport of the granules being produced to the outlet of the cutting chamber, air and/or dry gases and/or inert gases can be used as the second cooling medium.

Provision can be made that the granules are fed through first and second coolant media with coolant temperatures different from one another of the mutually separate and separately accessible first, second, and/or third coolant ports, wherein the second coolant medium can be used with a lower temperature than the first coolant medium.

The lower temperature of the second coolant medium of the second coolant flow, which primarily has the task of transporting the granules in the cutting chamber to the outlet and thereby creating a granule transport flow, has the advantage that the granules can be cooled intensively during transport in the cutting chamber. The somewhat higher temperature for cooling directly at the perforated plate can be adapted in advantageous manner for the purpose of preventing undercooling of the perforated plate below the softening point of the melt material and thus preventing clogging of the nozzle openings in the perforated plate.

In another example for carrying out the method, the granules can be cooled by first and second coolant media at different coolant pressures, wherein the second coolant medium can be applied with a higher coolant pressure than the first coolant medium. With the different coolant pressure it is possible to take into account that the volume in the cutting chamber in which the second coolant medium is effective as the granule transport medium is considerably larger than the volume in the region of the cutting knife in which the first coolant medium is effective.

Furthermore, provision can be made that the granules are cooled and transported by first and second coolant media at different coolant velocities, wherein the first coolant medium can be applied with a higher coolant velocity than the second coolant medium.

The different volumes in which the first and second coolant media are effective also have an effect in part here. Lastly, it may be advantageous in embodiments that the dwell time of the granules produced in the region of the cutting knife is kept small and that they are discharged from this cutting knife region with a relatively high coolant velocity. In any case, this also can be decided by the arrangement and orientation of the first coolant ports, since a material difference between the exemplary embodiments resides in whether the first coolant flow is delivered to the cutting knives with centrifugal or centripetal acceleration.

Provision can be made that, with the aid of different design of coolant ports, the granules are cooled by first and second coolant media from different coolant flow directions. Thus, a centrifugally oriented coolant flow direction can be provided for the first coolant medium to prevent premature contact by melt granules with the inner walls of the cutting chamber. For the second coolant medium, coolant flow directions that have an inclination relative to the central axis of the rotating cutting knife can be provided so that a helical transport direction toward the outlet can form in the cutting chamber.

In another example for carrying out the method, the granules can be cooled by first and second coolant media with different coolant densities. It can be advantageous here for the first coolant flow to have a coolant with lower coolant density than the second coolant flow, so that the mobility of the melt granules is increased in the region of the cutting knife and thus the dwell time of the melt granules in the region of the cutting knife is reduced relative to the granule transport flow of the coolant flow in the volume of the cutting chamber.

In yet another example for carrying out the invention the granules can be cooled by first and second coolant media with different coolant throughput, wherein the second coolant medium can be supplied with a higher coolant throughput. This higher coolant throughput for the second coolant medium can be partially due to the larger volume region that the second coolant medium must pass through.

Lastly, provision can be made that the granules are cooled by first and second coolant media with different coolant compositions. This difference in the coolant composition does not relate exclusively to the option already mentioned above of using gases, aerosols, or liquids as coolants; instead, liquids with different solvents or gases with different gas compositions can also exert an advantageous effect on the efficacy of a granulating method. At a minimum, these options for variation can considerably expand the range of optimization in an advantageous manner as compared to conventional exemplary embodiments for making granules from a melt material.

In another example for carrying out the method, at least one of the coolant flows can be delivered through a plurality of openings in the wall of the cutting chamber. The openings in the wall of the cutting chamber can be connected to annular feed chambers, wherein a corresponding first or second feed chamber can be provided for each of the first and second coolant flows in one of the embodiments of granulating devices.

The feed chambers can be supplied with coolant through separate first and second coolant inlets, which then feed the coolant media for the cooling process of the granules through differently shaped coolant ports in the wall of the cutting chamber. The openings in the wall of the cutting chamber can be provided as bores or as an annular slot or as delimited slots arranged radially, axially or at a slant for the directed orientation of the coolant flows.

In order to allow a different throughput to flow into the cutting chamber, not only can the openings in the walls have different cross-sections, but the openings can also be varied in their cross-sections. This variation can take place by means of a simple rotatable annular orifice consisting of a ring with openings having geometry the same as or similar to that of the coolant ports in the inner wall of the cutting chamber, by the means that the annular orifice can be guided or displaced on the inner wall.

The inflow angle for the coolant media into the cutting chamber can be designed to be different so that the coolant flows are fed through bores or slots that are inclined differently in space with regard to the axis of rotation and/or the plane of the perforated plate. Such spatially inclined bores or slots as coolant outlets can have the result that the first or the second coolant flow can be directed in a helical path toward the outlet.

Provision can be made that at least one of the coolant flows is delivered through an opening in the cutting knife head and through a hollow shaft. This can be especially advantageous for the first coolant flow, which experiences a cooling directly at the perforated plate at cutting of the melt material into granules, wherein the cooling air flow flows directly out into the cutting knife head through the bore.

Instead of delivering a first or second coolant medium through a hollow shaft, it is also possible to deliver this coolant flow through a coolant pipe section coaxially surrounding a cutting knife shaft. That has the advantage that a granulating device with a conventional cutting knife shaft can be operated.

In order to have three coolant flows act on the granules, the third coolant flow can either assist the cooling of the perforated plate or can be mixed with the second coolant flow to reinforce the transport of the granules or pellets to the outlet.

In order to set the cutting knife shaft in rotation, provision can be made to centrally couple a motor with the cutting knife shaft. In another embodiment of a granulating device, provision can be made to attach the motor laterally offset to a cutting housing and to drive a gear on the cutting knife shaft through a transmission. The cutting knife shaft can also be set in rotation by the laterally offset motor through a V-belt drive whose V-belt pulley works together with a V-belt pulley attached to the cutting knife shaft, however. A corresponding design using a toothed-belt drive, a chain, or the like is also possible.

The invention is explained in detail below with the aid of illustrative examples for carrying out the method.

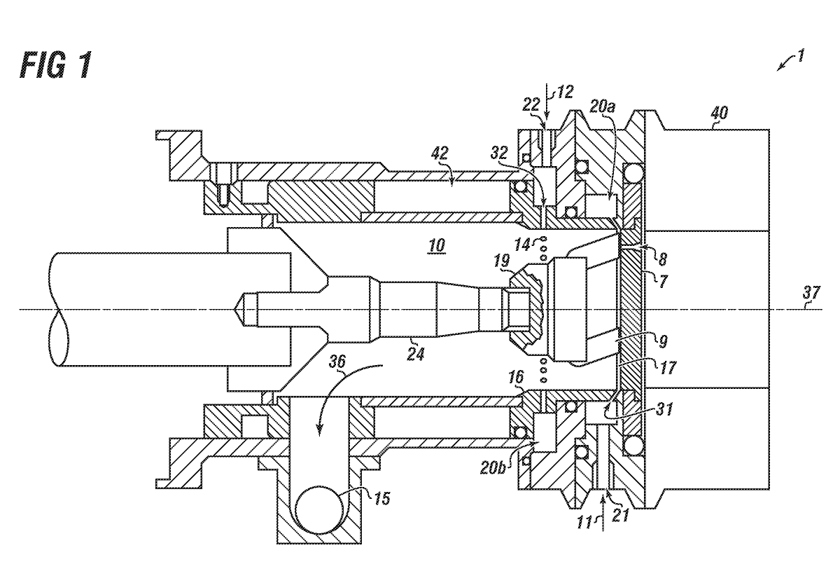

FIG. 1 shows a schematic, partially cross-sectional view of an embodiment of a granulating device 1 for carrying out the method according to a first example for carrying out the invention. In this embodiment, the granulating device 1 is coupled to an extrusion head 40 of an extruder in such a manner that a perforated plate 7 with nozzle openings 8 projects into a cutting chamber 10 of the granulating device 1. In the cutting chamber 10, a cutting knife shaft 24 with a cutting knife head 19 is set into rotation so that a cutting knife 9 cuts melt granules from a melt material that is pressed through openings 8.

The melt material can be pressed out of the openings 8 into granules. These granules can be cooled by a first coolant flow 11. To this end, the coolant flow 11 can be directed through a first coolant inlet 21a into a feed chamber 20a annularly surrounding the cutting chamber 10 in the region of the perforated plate, and in this embodiment of the invention flows out of a first coolant port 31a designed as an annular slot 17. To this end, the annular slot 17 can be oriented toward the region of the cutting knife 9.

Independently of this first coolant flow 11, downstream of the cutting knife 9 a second coolant flow 12 different from the first coolant flow 11 can be introduced into a second feed chamber 20b surrounding the cutting chamber 10 through a second coolant inlet 22. This second coolant flow 12 can be introduced into the cutting chamber 10 through bores 14 as second coolant ports 32 in the wall thereof, so that the granules acquire a centripetal acceleration on the way to the outlet 15 of the cutting chamber 10 and are thereby held longer in the volume of the cutting chamber 10 for cooling of the granules while avoiding contact with the wall of the cutting chamber 10, and form a granule transport flow 36 in the direction toward the outlet 15.

In the region of the housing of the granulating device 1, which is to say in particular, e.g., in the region of the cutting chamber 10, a tempering channel 42 or tempering channels 42 can be provided, through which a tempering fluid (liquid or gaseous) can flow. In embodiments, an additional tempering fluid, which otherwise does not come into contact with the other fluids of the method and can also be different therefrom is utilized.

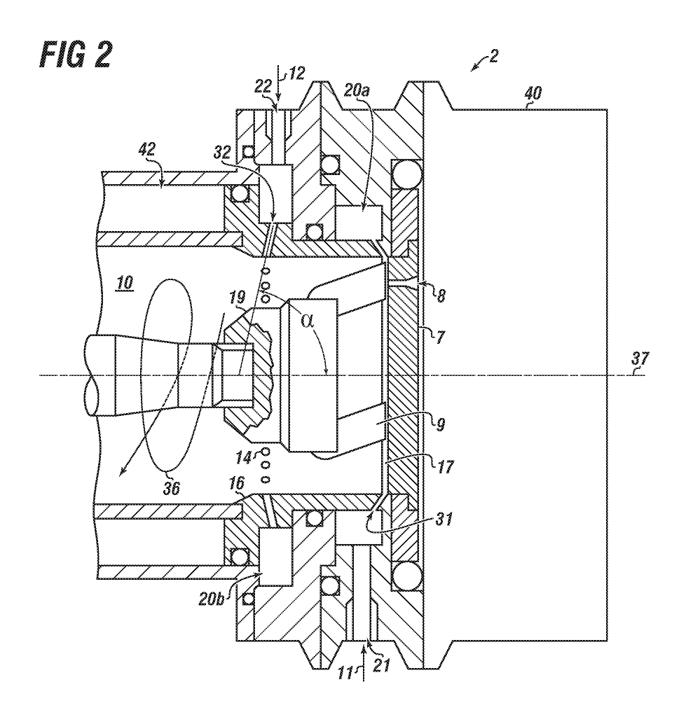

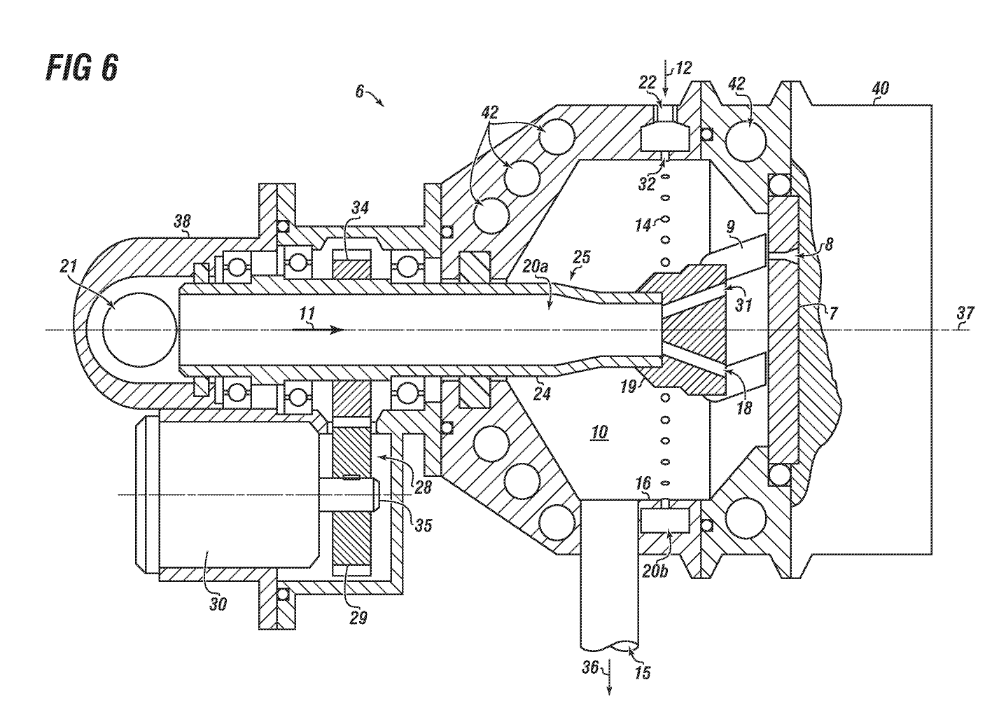

The tempering channel 42 can be arranged circumferentially around the cutting chamber 10, as is shown in FIGS. 1 and 2 (as well as in the drawing in FIG. 6 with multiple tempering channels). The tempering fluid can be provided to cool or heat the granulating device 1 depending on its relative temperature.

FIG. 2 shows a schematic, partially cross-sectional view of a granulating device 2 for carrying out the method according to a second example for carrying out the invention. Components with the same functions as in FIG. 1 are labeled with the same reference symbols in the figures that follow and are not discussed separately.

In this second embodiment of the invention, the first coolant flow 11 is routed to the region of the cutting knife 9 exactly as in FIG. 1; only the orientation of the second coolant flow 12 when flowing into the cutting chamber 10 is altered relative to FIG. 1 in that the second coolant ports 32 are arranged at an angle α with respect to the axis of rotation 37. In this way, an axial flow component is imposed in addition to a centripetal acceleration of the granules in the direction of the outlet, not shown in this figure, so that the second coolant flow 12 transitions to a helical granule transport flow 36. As a result of the two independent coolant flows 11 and 12 it is possible to use coolant media in different physical states, with different coolant temperatures, coolant velocities, coolant flow directions as in this example, coolant throughput and/or coolant compositions for optimization of the granulating method.

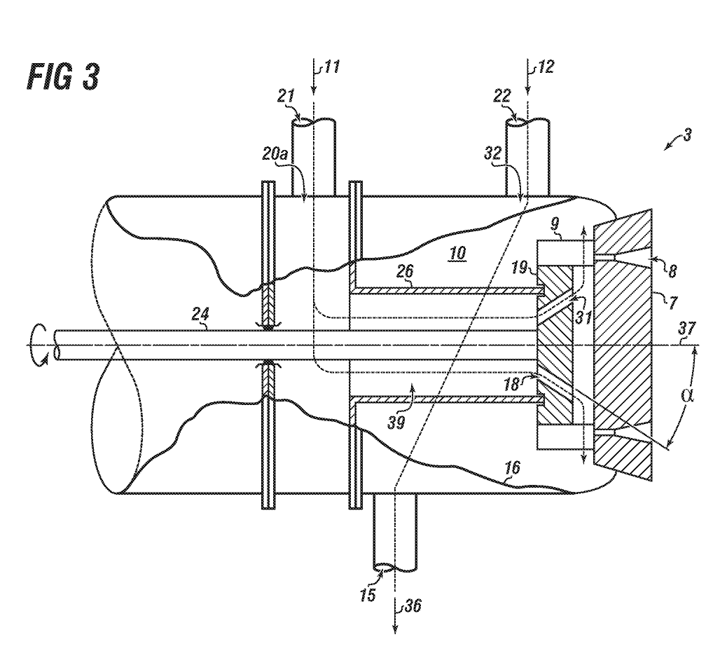

FIG. 3 shows a schematic, partially cross-sectional view of a granulating device 3 for carrying out the method according to a third example for carrying out the invention. In this granulating device 3 the first coolant flow 11 takes place not through a feed chamber that radially surrounds the cutting chamber 10 as in FIG. 1 or 2, but instead through a feed chamber 20a flange-mounted on the cutting chamber 10 that transitions coaxially with the cutting knife shaft 24 into a coolant pipe section 26 and forms a coaxial intermediate space 39 between the cutting knife shaft 24 and the coolant pipe section 26.

Into this intermediate space 39 flows the first coolant flow 11, which is labeled with a dashed-and-double-dotted line, from the flange-mounted feed chamber 20a to first coolant ports 31a in the cutter head 19. The first coolant ports 31a in the cutter head 19 can be arranged at an angle α between 0° and 90°, preferably between 15° and 60° with respect to the axis of rotation 37. In FIG. 3 this angle α is 30°. The first coolant flow 11 accelerates the granules in a centrifugal direction, in contrast to the examples for carrying out the method in FIGS. 1 and 2.

The second coolant flow 12 is introduced through a second coolant inlet 22 that likewise is not delivered by means of a feed chamber surrounding the cutting knife chamber 10, but instead is introduced directly into the cutting chamber 10 through a second coolant inlet 22 through a second coolant port 32. The second coolant flow 12 flows outside around the coolant pipe section 26 and the process both cools and transports granules, forming the granule transport flow 36 to the outlet 15, as is indicated by the dotted-and-dashed line. Meanwhile, the first coolant flow 11 flows inside the coolant pipe section 26 through the bores in the cutting knife head 19 in the direction toward the cutting knife 9.

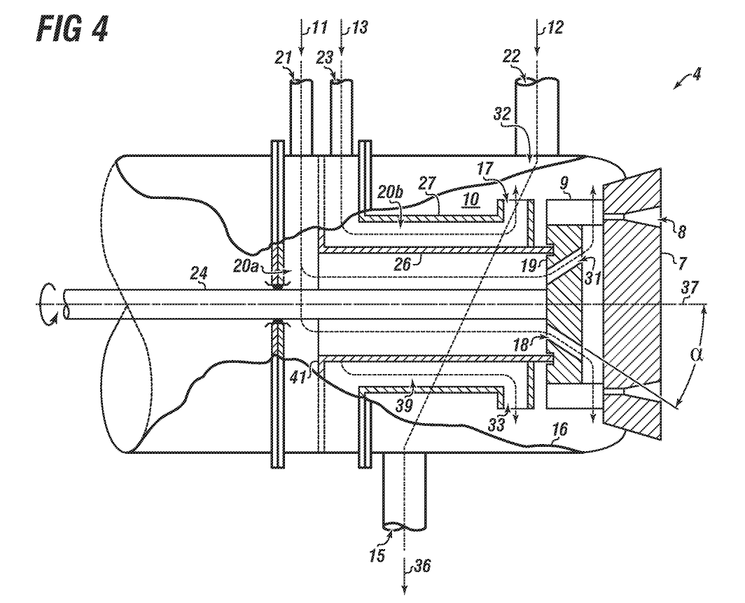

FIG. 4 shows a schematic, partially cross-sectional view of a granulating device 4 for carrying out the method according to a fourth example for carrying out the invention. The example for carrying out the method according to FIG. 4 differs from the preceding FIGS. 1-3 in that three coolant flows 11, 12, and 13 can now be independently made available for cooling and transporting the granules, wherein the first coolant flow 11 is delivered to the cutting knife head 19 exactly as in FIG. 3, and from there is made available through the first coolant ports 31a in the cutting knife head 19 to the cutting knives 9.

The second coolant flow 12 is routed directly into the cutting chamber 10 through a second coolant inlet 22 and flows around the coolant pipe sections 26 and 27 that are coaxial with the cutting knife shaft 24, as indicated by the dotted-and-dashed line, and leaves the cutting chamber 10 as the granule transport flow 36 with the granules through the outlet 15.

The third coolant flow 13 supports the granule transport flow 12 and is delivered through a second feed chamber 20b that is flange-mounted on the cutting chamber and is separated from the first flange-mounted feed chamber 20a by a dividing wall 41 and transitions into a second coolant pipe section 27 that is coaxial with the first coolant pipe section 26 and that ends in an annular slot nozzle 17 as the third coolant port 33 downstream of the cutter head 19, whence the third coolant flow 13, indicated by a dashed-and-triple-dotted line, flows out with a centrifugal flow component.

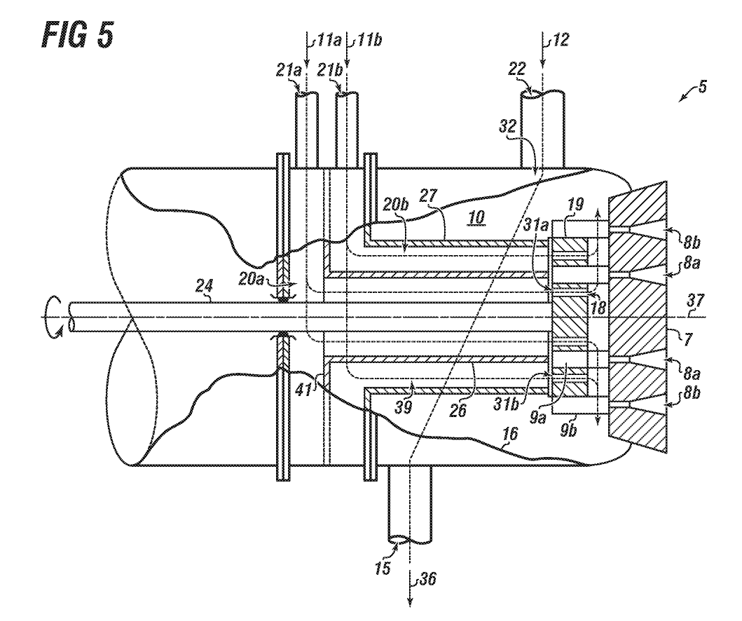

FIG. 5 shows a schematic, partially cross-sectional view of a granulating device 5 for carrying out the method according to a fifth example for carrying out the invention, wherein this method differs from the preceding in that not just one ring of openings 8 is provided in the perforated plate 7, but instead the openings 8a and 8b are arranged in two concentric rings in the perforated plate 7.

Accordingly, two first coolant flows 11a and 11b are delivered through separate first coolant inlets 21a and 21b to the cutting knife head 19. To this end, this granulating device has the same feed chambers 20a and 20b as in FIG. 4 with the difference that the second feed chamber 20b with its coaxial second coolant pipe section 27 supplies a second ring of third coolant ports 31b with a third coolant.

The second coolant flow 12 flows through a second inlet 22 and a second coolant port 32, exactly as in FIG. 4, directly into the cutting chamber 10 with no feed chamber.

In the cutting chamber 10, the second coolant flow 12 flows around the coolant pipe section 27 and transports the granules to the outlet 15 while cooling them.

FIG. 6 shows a schematic, partially cross-sectional view of a granulating device 6 for carrying out the method according to a sixth example for carrying out the invention, in which a first coolant flow 11 of a first coolant medium is now delivered to a first feed chamber 20a extending from a hollow space of a hollow shaft 25 of the cutting knife shaft 24 to the cutting knife head 19, and flows through bores 18 and first coolant ports 31a in the cutting knife head 19 to the cutting knives 9.

The second coolant flow 12 is delivered to the cutting chamber 10 through a second annular feed chamber 20b, such as is known from FIGS. 1 and 2, through second coolant ports 32, which are provided as bores 14 in the wall 16 of the cutting chamber 10, and is discharged from the outlet 15 of the cutting chamber 10 as the granule transport flow 36, carrying the granules with it. In order to be able to introduce the first coolant flow 11 into the hollow space of the cutting knife shaft 24, a feed section 38, which can be connected to a feed line, is located at the end of the hollow shaft 25.

In this embodiment, a motor 30 is located downstream of the cutting chamber 10 and laterally offset from the axis of rotation 37. A pinion 34 is located on the hollow shaft. The pinion 34 is driven by the motor 30 through a transmission 28. The transmission 28 has at least one drive gear 29 that is attached in a rotationally fixed manner to an output shaft 35 of the motor 30 and in this embodiment meshes with the gear 34 on the cutting knife shaft 24.

Even though at least exemplary examples for carrying out the method according to the invention have been presented in the preceding description, various changes and modifications of the method steps may be undertaken. The specified examples for carrying out the method are not intended to restrict in any way the scope of application or the applicability of the method for making granules from a melt material. Instead, the above description provides a person skilled in the art with a plan for implementing multiple examples for carrying out the method for making granules, wherein numerous changes from the details of the granulating device described in exemplary embodiments may be made to the function and design of the granulating device without departing from the scope of protection of the appended claims with regard to examples for carrying out the method for making granules and their legal equivalents.

While the invention has been described with emphasis on the embodiments, it should be understood that within the scope of the appended claims, the embodiments might be practiced other than as specifically described herein.

What is claimed is:

1. A method for making granules from a melt material comprising:
a) producing and extruding a melt material;
b) pressing the melt material through nozzle openings of a perforated plate in a cutting chamber;
c) cutting the melt material emerging from the nozzle openings of the perforated plate into molten granules in the cutting chamber by at least one rotating cutting knife that sweeps across the nozzle openings;
d) delivering a first coolant flow of a first coolant medium through a first coolant inlet to at least one first coolant port; and
e) delivering a second coolant flow of a second coolant medium different from the first coolant medium through a second coolant inlet to at least one second coolant port downstream of the perforated plate, wherein the second coolant flow additionally cools and guides the granules to an outlet of the cutting chamber.

2. The method of claim 1, wherein a third coolant flow of a third coolant medium is provided that is delivered through at least one third coolant port, wherein the third coolant flow additionally cools the granules.

3. The method of claim 1, wherein two different first coolant flows cool the granules proximate the perforated plate.

4. The method of claim 1, wherein the granules are cooled by the first coolant medium and the second coolant medium with different physical states, wherein an aerosol or mist is used as the first coolant medium and a dry gas or inert gas as the second coolant medium or an aerosol or mist is used as the second coolant medium and a dry gas or inert gas as the first coolant medium.

5. The method of claim 1, wherein the second coolant medium has a lower temperature than the first coolant medium.

6. The method of claim 1, wherein the second coolant medium is applied with a higher coolant pressure than the first coolant medium.

7. The method of claim 1, wherein the first coolant medium is applied with a higher coolant velocity than the second coolant medium.

8. The method of claim 1, wherein the first coolant medium and the second coolant medium are introduced from different coolant flow directions.

9. The method of claim 1, wherein the first coolant medium and the second coolant medium have different coolant densities.

10. The method of claim 1, wherein the second coolant medium is supplied with a higher coolant throughput than the first coolant medium.

11. The method of claim 1, wherein the first coolant medium and the second coolant medium have different coolant compositions.

12. The method of claim 1, wherein the first coolant medium or the second coolant medium is delivered through a plurality of bores in a wall of the cutting chamber, wherein the bores are supplied through an annular feed chamber by which the cutting chamber is surrounded.

13. The method of claim 12, wherein the first coolant medium or the second coolant medium is delivered through at least one annular slot in the wall of the cutting chamber.

14. The method of claim 12, wherein the first coolant medium or the second coolant medium is delivered through a plurality of delimited slots arranged radially, axially, or at a slant in the wall of the cutting chamber.

15. The method of claim 12, wherein the first coolant medium or the second coolant medium is delivered through a plurality of bores spatially inclined relative to a center axis of the cutting chamber and a plane of the perforated plate.

16. The method of claim 1, wherein the first coolant medium or the second coolant medium is delivered through at least one opening in a cutting knife head and through a hollow shaft.

17. The method of claim 16, wherein the first coolant medium or the second coolant medium is delivered through the at least one opening in the cutting knife head and through a coolant pipe section coaxially surrounding a cutting knife shaft.

18. The method of claim 17, wherein two independent coolant flows are delivered through the at least one opening into the cutting knife head and through two coolant pipe sections coaxial with the cutting knife shaft.

19. The method of claim 17, wherein the cutting knife shaft is driven by a motor centrally attached to the cutting chamber.

20. The method of claim 17, wherein the cutting knife shaft is driven by a motor located laterally on the cutting chamber through a transmission whose drive gear meshes with a gear on the cutting knife shaft.

21. The method of claim 20, wherein the cutting knife shaft is driven by a motor located laterally on the cutting chamber through a V-belt drive whose V-belt pulley works together with a V-belt pulley attached to a drive shaft of the motor cutting knife shaft, or is driven by a toothed belt or a chain.
